(19) United States
(12) Patent Application Publication
(10) Pub. No.: US 2024/0292303 A1
(43) Pub. Date: Aug. 29, 2024

(54) APPARATUS, A METHOD, AND A COMPUTER PROGRAM FOR ADDRESSING A RADIO LINK FAILURE CONDITION

(71) Applicant: Nokia Technologies Oy, Espoo (FI)

(72) Inventors: Jussi-Pekka KOSKINEN, Oulu (FI); Samuli Heikki Turtinen, Oulu (FI)

(21) Appl. No.: 18/431,671

(22) Filed: Feb. 2, 2024

(30) Foreign Application Priority Data
Feb. 27, 2023 (FI) 2302805.3

(51) Int. Cl. H04W 36/30; H04W 36/00

(52) U.S. Cl. CPC H04W 36/305; H04W 36/0058; H04W 36/0061; H04W 36/00835

(57) ABSTRACT

An apparatus comprising: means for receiving a message from a network node on a source cell indicating one or more lower layer mobility candidate cells; means for determining a failure with the source cell; and means for, after the determining of the failure, attempting at least one of cell selection or radio resource control re-establishment on one or more of the one or more candidate cells.

### FIELD OF THE DISCLOSURE

The present disclosure relates to an apparatus, a method, and a computer program and in particular, but not exclusively to an apparatus, a method, and a computer program for addressing a radio link failure condition.

### BACKGROUND

A communication system can be seen as a facility that enables communication sessions between two or more entities such as communications devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined.

### SUMMARY

According to an aspect, there is provided an apparatus comprising an apparatus comprising: means for receiving a message from a network node on a source cell indicating one or more lower layer mobility candidate cells; means for determining a failure with the source cell; and means for, after the determining of the failure, attempting at least one of cell selection or radio resource control re-establishment on one or more of the one or more candidate cells.

The failure may comprise a radio link failure.

The attempting at least one of cell selection or radio resource control re-establishment on one or more of the one or more candidate cells may be performed in the absence of a path switch command from the network.

The means for attempting at least one of cell selection or radio resource control re-establishment may be for attempting to receive system information from one or more or the one or more candidate cells.

The means for attempting at least one of cell selection or radio resource control re-establishment may prioritize one or more of the one or more candidate cells satisfying one or more thresholds or at least one condition.

The at least one threshold may comprise a measurement power threshold or a quality threshold.

The at least one condition may comprise that one or more of the one or more candidate cells has been reported in a measurement report to the network node.

The message may comprise configuration information for one or more of the one or more candidate cells.

The apparatus may comprise means for causing a measurement report to be transmitted to the network node said message being received in response to said measurement report.

The lower layer mobility may comprise a L1/L2 triggered mobility.

The apparatus may comprise means for attempting completion of lower layer mobility to a target cell selected from one of said one or more candidate cells, in response to the determining of the failure, and when said attempt to complete the lower layer mobility to said target cell is unsuccessful, attempting at least one of cell selection or radio resource control re-establishment on one or more of the one or more candidate cells.

The apparatus may comprise means for synchronising with one or more of the one or more candidate cells.

The apparatus may comprise means for acquiring timing advance information for one or more of the one or more candidate cells.

The apparatus may comprise means for sending information to the network node, said information indicating that the apparatus supports at least one of: completion of lower layer mobility to a target cell selected from the one or more candidate cells after a failure; or after a failure, attempting at least one of cell selection or radio resource control re-establishment on one or more of the one or more candidate cells.

The apparatus may be in or be a communications device.

According to another aspect there is provided an apparatus comprising at least one processor and at least one memory including computer code for one or more programs, the at least one memory and the computer code configured, with the at least one processor, to cause the apparatus at least to: receive a message from a network node on a source cell indicating one or more lower layer mobility candidate cells; determine a failure with the source cell; and after the determining of the failure, attempt at least one of cell selection or radio resource control re-establishment on one or more of the one or more candidate cells.

The failure may comprise a radio link failure.

The apparatus may be caused to attempt at least one of cell selection or radio resource control re-establishment on one or more of the one or more candidate cells in the absence of a path switch command from the network.

The apparatus may be caused to receive system information from the one or more of the one or more candidate cells.

The apparatus may be caused to prioritize one or more of the one or more candidate cells satisfying one or more thresholds or at least one condition.

The at least one threshold may comprise a measurement power threshold or a quality threshold.

The at least one condition may comprise that one or more of the one or more candidate cells has been reported in a measurement report to the network node.

The message may comprise configuration information for the one or more of the one or more candidate cells.

The apparatus may be caused to cause a measurement report to be transmitted to the network node and receiving said information in response to said measurement report.

The lower layer mobility may comprise a L1/L2 triggered mobility.

The apparatus may be caused to attempt completion of lower layer mobility to a target cell selected from one of said one or more candidate cells, in response to the determining of the failure, and when said attempt to complete the lower layer mobility to said target cell is unsuccessful, attempt at least one of cell selection or radio resource control re-establishment on one or more of the one or more candidate cells.

The apparatus may be caused to synchronise with one or more of the one or more candidate cells.

The apparatus may be caused to acquire timing advance information for one or more of the one or more candidate cells.

The apparatus may be caused to send information to the network node, said information indicating that the apparatus supports at least one of: completion of lower layer mobility to a target cell selected from the one or more candidate cells after a failure; or after a failure, attempting at least one of cell selection or radio resource control re-establishment on one or more of the one or more candidate cells.

The apparatus may be or be in a communications device.

According to another aspect, there is provided a method comprising: receiving a message from a network node on a source cell indicating one or more lower layer mobility candidate cells; determining a failure with the source cell; and after the determining of the failure, attempting at least one of cell selection or radio resource control re-establishment on one or more of the one or more candidate cells.

The failure may comprise a radio link failure.

The method may comprise attempting at least one of cell selection or radio resource control re-establishment on one or more of the one or more candidate cells in the absence of a path switch command from the network.

The method may comprise attempting to receive system information from the one or more of the one or more candidate cells.

The method may comprise prioritizing one or more of the one or more candidate cells satisfying one or more thresholds or at least one condition.

The at least one threshold may comprise a measurement power threshold or a quality threshold.

The at least one condition may comprise that one or more of the one or more candidate cells has been reported in a measurement report to the network node.

The message may comprise configuration information for the one or more of the one or more candidate cells.

The method may comprise causing a measurement report to be transmitted to the network node and receiving said information in response to said measurement report.

The lower layer mobility may comprise a L1/L2 triggered mobility.

The method may comprise attempting completion of lower layer mobility to a target cell selected from one of said one or more candidate cells, in response to the determining of the failure, and when said attempt to complete the lower layer mobility to said target cell is unsuccessful, attempting at least one of cell selection or radio resource control re-establishment on one or more of the one or more candidate cells.

The method may comprise synchronising with one or more of the one or more candidate cells.

The method may comprise acquiring timing advance information for one or more of the one or more candidate cells.

The method may comprise sending information to the network node, said information indicating that the apparatus supports at least one of: completion of lower layer mobility to a target cell selected from the one or more candidate cells after a failure; or after a failure, attempting at least one of cell selection or radio resource control re-establishment on one or more of the one or more candidate cells.

The method may be performed in an apparatus. The apparatus may be or be in a communications device.

According to another aspect, there is provided an apparatus comprising: means for transmitting to communications device: information indicating one or more lower mobility candidate cells; and configuration information, said configuration information indicating to the communications device that the communications device is to attempt at least one of cell selection or radio resource control re-establishment when there is a failure with a source cell.

The information indicating one or more lower mobility candidate cells and configuration information may be received in the same or different messages.

The failure may comprise a radio link failure.

The information indicating one or more lower mobility candidate cells may comprise configuration information for one or more of the one or more candidate cells.

The apparatus may comprise means for receiving a measurement report from the communications device.

The lower layer mobility may comprise a L1/L2 triggered mobility.

The apparatus may comprise means for receiving from the communications device information that the communications device supports at least one of: completion of lower layer mobility to a target cell selected from the one or more candidate cells after a failure; or after a failure, attempting at least one of cell selection or radio resource control re-establishment on one or more of the one or more candidate cells.

The apparatus may comprise means for determining a failure with the source cell and in response starting a timer to delay removal of resources associated with the one or more candidate cells.

The timer may be started in the absence of a path switch command being caused to be transmitted to the communications device.

The apparatus may be provided in or be an access node.

According to an aspect, there is provided a method comprising: transmitting to communications device: information indicating one or more lower mobility candidate cells; and configuration information, said configuration information indicating to the communications device that the communications device is to attempt at least one of cell selection or radio resource control re-establishment when there is a failure with a source cell.

The information indicating one or more lower mobility candidate cells and configuration information may be received in the same or different messages.

The failure may comprise a radio link failure.

The information indicating one or more lower mobility candidate cells may comprise configuration information for one or more of the one or more candidate cells.

The method may comprise receiving a measurement report from the communications device.

The lower layer mobility may comprise a L1/L2 triggered mobility.

The method may comprise receiving from the communications device information that the communications device supports at least one of: completion of lower layer mobility to a target cell selected from the one or more candidate cells after a failure; or after a failure, attempting at least one of cell selection or radio resource control re-establishment on one or more of the one or more candidate cells.

The method may comprise determining a failure with the source cell and in response starting a timer to delay removal of resources associated with the one or more candidate cells.

The timer may be started in the absence of a path switch command being caused to be transmitted to the communications device.

The method may be performed by an apparatus. The apparatus may be or in an access node.

According to another aspect there is provided an apparatus comprising at least one processor and at least one memory including computer code for one or more programs, the at least one memory and the computer code configured, with the at least one processor, to cause the apparatus at least to: transmit to a communications device: information indicating one or more lower mobility candidate cells; and configuration information, said configuration information indicating to the communications device that the communications device is to attempt at least one of cell selection or radio resource control re-establishment when there is a failure with a source cell.

The information indicating one or more lower mobility candidate cells and configuration information may be received in the same or different messages.

The failure may comprise a radio link failure.

The information indicating one or more lower mobility candidate cells may comprise configuration information for one or more of the one or more candidate cells.

The apparatus may be caused to receive a measurement report from the communications device.

The lower layer mobility may comprise a L1/L2 triggered mobility.

The apparatus may be caused to receive from the communications device information that the communications device supports at least one of: completion of lower layer mobility to a target cell selected from the one or more candidate cells after a failure; or after a failure, attempting at least one of cell selection or radio resource control re-establishment on one or more of the one or more candidate cells.

The apparatus may be caused to determine a failure with the source cell and in response starting a timer to delay removal of resources associated with the one or more candidate cells.

The timer may be started in the absence of a path switch command being caused to be transmitted to the communications device.

The apparatus may be or in an access node.

According to a further aspect, there is provided a computer program comprising instructions, which when executed by an apparatus, cause the apparatus to perform any of the methods set out previously.

According to a further aspect, there is provided a computer program comprising instructions, which when executed cause any of the methods set out previously to be performed.

According to an aspect there is provided a computer program comprising computer executable code which when cause any of the methods set out previously to be performed.

According to an aspect, there is provided a computer readable medium comprising program instructions stored thereon for performing at least one of the above methods.

According to an aspect, there is provided a non-transitory computer readable medium comprising program instructions which when executed by an apparatus, cause the apparatus to perform any of the methods set out previously.

According to an aspect, there is provided a non-transitory computer readable medium comprising program instructions which when executed cause any of the methods set out previously to be performed.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

### BRIEF DESCRIPTION OF THE FIGURES

Embodiments will now be described, by way of example only, with reference to the accompanying Figures in which:

FIG. 1 shows an example system architecture;

FIG. 2 shows a schematic diagram of an example 5G core network and radio access part;

FIG. 3 shows a schematic diagram of an example apparatus;

FIG. 4 shows a schematic diagram of a communications device;

FIG. 5 shows a signalling flow;

FIG. 6 shows a first method of some embodiments;

FIG. 7 shows a second method of some embodiments;

FIG. 8 shows a third method of some embodiments; and

FIG. 9 shows a fourth method of some embodiments.

### DETAILED DESCRIPTION OF THE FIGURES

The following description gives an exemplifying description of some embodiments. Although the specification may refer to “an”, “one”, or “some” examples or embodiment(s) in several locations of the text, this does not necessarily mean that each reference is made to the same example of embodiment(s), or that a particular feature only applies to a single example or embodiment. Single features of different examples and embodiments may also be combined to provide other embodiments.

Wireless communications systems provide wireless communications to devices connected therein. Typically, an access point such as a base station is provided for enabling the communications. In the following, different scenarios will be described using, as an example of an access architecture, a 3GPP 5G radio access architecture.

However, embodiments are not necessarily limited to such an architecture. Some examples of other options for suitable systems are the universal mobile telecommunications system (UMTS) radio access network (UTRAN or E-UTRAN), long term evolution (LTE), LTE-A (LTE advanced), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS) or any combination and further development thereof.

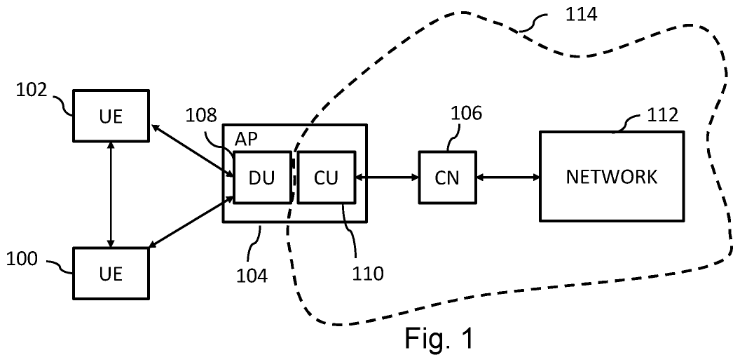

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 100 and 102. The devices 100 and 102 are configured to be in a wireless connection on one or more communication channels with a node 104. The node 104 is further connected to a core network 106. In one example, the node 104 may be an access node such as a base station or (e/g) NodeB serving devices in a cell. In one example, the node 104 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server, or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 106 (CN). Depending on the deployed technology, the (e/g) NodeB is connected to a serving and packet data network gateway (S-GW and P-GW) or user plane function (UPF), for routing and forwarding user data packets and for providing connectivity of devices to one or more external packet data networks, and to a mobile management entity (MME) or access mobility management function (AMF), for controlling access and mobility of the devices. Exemplary embodiments of a device are a subscriber unit, a user device, a user equipment (UE), a user terminal, a terminal device, a mobile station, a mobile device, etc.

The device typically refers to a mobile or static device (e.g. a portable or non-portable computing device) that includes wireless mobile communications devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, a wireless interface card or other wireless interface facility (e.g., USB dongle) and multimedia device. It should be appreciated that a device may also be a nearly exclusive uplink only device, of which an example is a camera or video camera loading images or video clips to a network. The device may be a machine-type communications (MTC) device, an Internet of things (IoT) type communications device or a Cellular Internet of things (CIoT) device or any combinations of these. The device may be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may utilise cloud. In some applications, a device may comprise a user portable device with radio parts (such as a watch, earphones, or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or in some embodiments a layer 3 relay node) is configured to perform one or more of user equipment functionalities.

Additionally, although the apparatuses have been depicted as single entities, different units, processors and/or memory units (not all shown in FIG. 1) may be implemented.

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes, or hosts. Application of cloud RAN architecture enables RAN real time functions being carried out at or close to a remote antenna site (e.g. in a distributed unit, DU 108 of an access point) and non-real time functions being carried out in a centralized manner (e.g. in a centralized unit, CU 110 of an access point).

It is obvious for a person skilled in the art that the depicted system is only an example of a part of a radio access system and in practice, the system may comprise a plurality of (e/g) NodeBs, the device may have access to a plurality of radio cells and the system may comprise also other apparatuses, such as physical layer relay nodes or other network elements, etc. In a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

In the following examples, the communications device is referred to as a UE. However, it should be appreciated that the communications device can any suitable communications device.

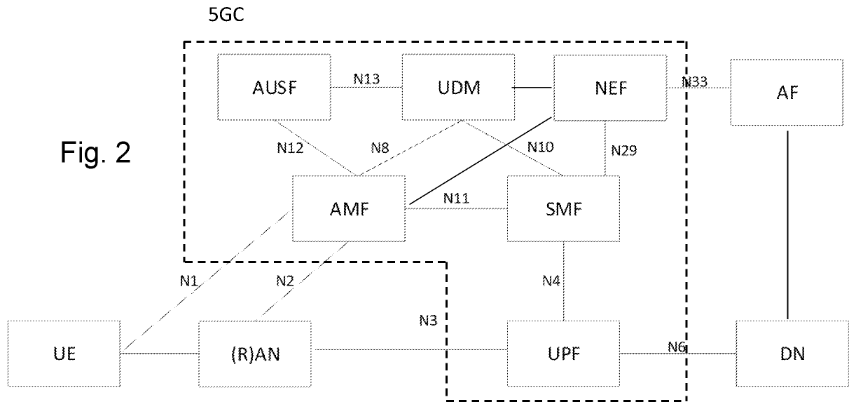

FIG. 2 shows a schematic representation of a 5G system (5GS). The 5GS may comprises a terminal, a (radio) access network ((R) AN), a 5G core network (5GC), one or more application functions (AF) and one or more data networks (DN). The 5G (R) AN may comprise one or more gNodeB (gNB) distributed unit functions connected to one or more gNodeB (gNB) centralized unit functions. The 5GC may comprise an access management function (AMF), a session management function (SMF), an authentication server function (AUSF), a user data management (UDM), a user plane function (UPF) and/or a network exposure function (NEF).

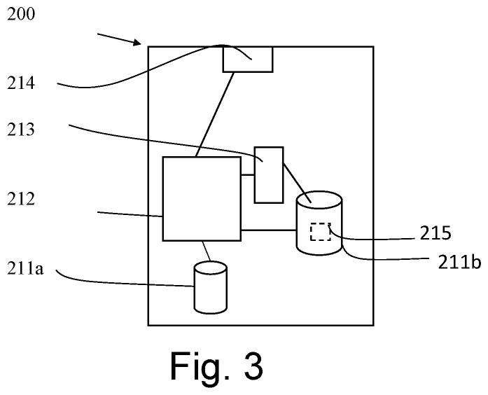

FIG. 3 illustrates an example of an apparatus 200. The apparatus may be provided in or be a communications device. The apparatus may be provided in or be a base station other access node. The apparatus may be provided in or be a DU or a CU. The apparatus may comprise at least one memory. The at least one memory may comprise at least one random access memory (RAM) 211a and/or at least one read only memory (ROM) 211b. The apparatus may comprise at least one processor 212, 213. The apparatus may comprise an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b or other memory.

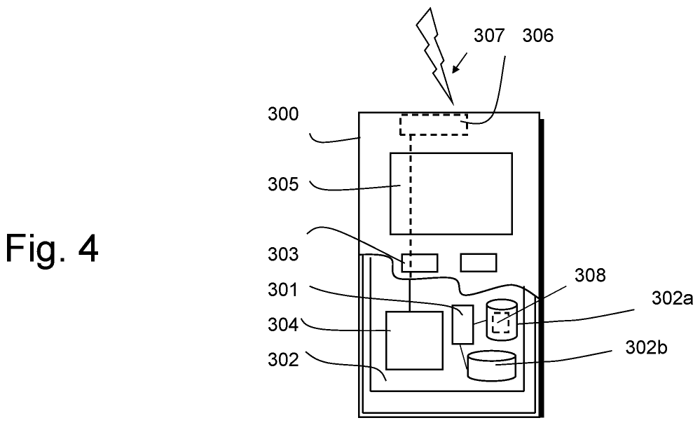

FIG. 4 illustrates an example of a communications device 300, such as the communications device illustrated on FIG. 1. The communications device 300 may be provided by any device capable of sending and receiving radio signals. Non-limiting examples have been discussed previously. The communications device 300 may provide, for example, communication of data for carrying communications. The communications may be one or more of voice, electronic mail (email), text message, multimedia, data, machine data and so on.

The communications device 300 may receive signals over an air or radio interface 307 via appropriate apparatus for receiving and may transmit signals via appropriate apparatus for transmitting radio signals. In FIG. 4 transceiver apparatus is designated schematically by block 306. The transceiver apparatus 306 may be provided for example by means of a radio part and associated antenna arrangement. The antenna arrangement may be arranged internally or externally to the mobile device.

The communications device 300 may be provided with at least one processor 301 and at least one memory. The at least one memory may be at least one ROM 302a and/or at least one RAM 302b. The communications device may comprise other possible components 303 for use in software and hardware aided execution of tasks it is designed to perform, including control of access to and communications with access systems and other communications devices. The at least one processor 301 is coupled to the RAM 302a and the ROM 211b. The at least one processor 301 may be configured to execute an appropriate software code 308. The software code 308 may for example allow to perform one or more of the present aspects. The software code 308 may be stored in the ROM 302b or other suitable memory.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

As user equipment (UE) moves through a wireless communication system, it may move through cells that comprise regions of radio coverage that are supported by one or more network access node. Maintaining an ability for a UE to communicate effectively with the wireless communication system as it moves through regions of radio coverage is typically referred to as mobility. Layer 1 or layer 2, sometimes termed lower layer, triggered mobility is being increasingly considered to reduce the latency, overhead and interruption time associated with a UE moving between the different cells.

Some embodiments are concerned with lower layer triggered mobility LTM for a user equipment moving through a communication network with multiple network nodes supporting radio coverage in multiple cells. Each network node supports radio coverage in one or more cells and a user equipment will switch between cells as it moves.

Lower Layer triggered Mobility (LTM), marked also as L1/2 inter-cell mobility, is an upcoming objective to enhance mobility and may be used in new radio networks. According to the paradigm, the decision about the cell change may be based on layer 1 measurements (physical layer) and may be made at the L2 MAC (medium access control) layer.

In a network comprising gNBs that may have a central unit and one or more distributed units, the decision about the cell change may be made in the Distributed Unit or node (DU).

When the UE moves from the coverage area of one cell to another cell, at some point a serving cell change needs to be performed. Without lower level mobility, serving cell change is triggered by L3 measurements and is done by RRC signalling triggered Reconfiguration with Synchronisation for change of a serving cell. The serving cell may be a PCell (primary cell), PSCell, (primary secondary cell) or other serving cell. All cases involve complete L2 (and L1) resets, which may lead to longer latency, larger overhead and longer interruption time than beam switch mobility. The goal of L1/L2 mobility enhancements is to enable a serving cell change via L1/L2 signalling, with the aim of reducing the latency, overhead and interruption time.

In some embodiments the network provides configuration information to the UE that includes configuration information for one or multiple LTM candidate target cells.

In some embodiments the UE stores the configuration of the LTM candidate target cell(s).

The UE may then perform DL (downlink) synchronization and TA (timing advance) acquisition with candidate target cell(s) from the list before receiving the LTM cell switch command from the network, so that once that command is received the UE is prepared to complete a switch to a selected one of multiple target cells.

When a UE moves from the coverage area of one cell to another cell, at some point a serving cell change needs to be performed. Currently a serving cell change is triggered by L3 (layer 3) measurements and is done by RRC (Radio Resource Control) signalling triggered reconfiguration with synchronisation. This may be for a change of PCell (primary cell), a change of a PSCell (primary secondary cell), or a release or addition of a SCell (secondary cell).

This involves complete L2 (layer 2) and L1 (layer 1) reset. This may lead to longer latency, a larger overhead and/or a longer interruption time than beam switch mobility.

L1 layer 1 is the physical layer, L2 layer 2 is the MAC (Media Access Control) layer, and L3 layer 3 is the RRC layer.

One aim of L1/L2 mobility enhancements may be to enable a serving cell change via L1/L2 signalling. This may reduce the latency, overhead and/or interruption time.

A network NW may provide configuration to the UE including one or multiple LTM candidate target cells. The UE stores the configuration of LTM candidate target cell(s). The UE may perform DL synchronization and TA acquisition with candidate target cell(s) before receiving the LTM cell switch command.

Some embodiments may address the issue that a RLF (radio link failure) with a source cell may occur before a cell switch command is received. Currently, the UE would need to start a re-establishment procedure where cell selection is performed for finding proper cell.

In some embodiments, in the event of a RLF failure occurring before a cell switch command is received, the UE selects one of the LTM candidate target cells. The LTM candidate target cell may be considered to be already prepared i.e. UE context is available.

In contrast, the approach in which the RRC reestablishment procedure for a cell change is executed may be more time consuming compared to attempting to use one of the LTM candidate target cells.

It should be noted that if the RRC reestablishment procedure results in the UE selecting a cell which is not prepared i.e., UE context is not available, the fetching of that UE context for that cell may cause further delay.

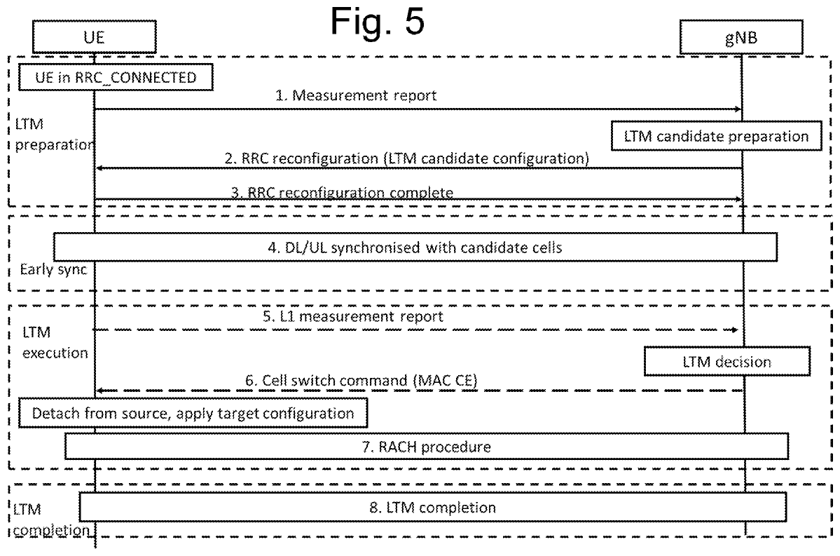

FIG. 5 show a flowchart of a LTM (L1/L2 triggered mobility). The overall procedure for LTM is shown in FIG. 5. The gNB entity may comprise a CU entity and one or more DU entities. A DU may provide one or more cells. The CU hosts radio functions such as RRC and PDCP (packet data convergence protocol) whereas DU hosts PHY (physical), MAC (medium access control) and RLC (radio link control) layers.

FIG. 5 illustrates four phases of LTM:

LTM Preparation: the target cells may be prepared. This may be based on UE measurements. The measurements may be L3 measurements.

Early synchronisation;

LTM Execution: the network dictates to the UE to which cell of the prepared ones it should be handed over based on the L1 reports of the UE; and LTM Completion: the UE completes the HO to the target cell with context release and path switch taking place.

Subsequent LTM is done by repeating the early synchronization, LTM execution, and LTM completion steps without releasing other candidates after each LTM completion.

The procedure for LTM is as follows.

The LTM preparation phase will now be described.

As referenced 1, the UE sends a measurement report message to the gNB.

The gNB decides to use LTM and initiates LTM candidate preparation.

As referenced 2, the gNB transmits an RRC reconfiguration message to the UE including the configuration of one or more LTM candidate target cells.

As referenced 3, the UE stores the configuration of the one or more LTM candidate target cells and transmits a RRC reconfiguration complete message to the gNB.

The early synchronization phase will now be described.

As referenced 4, the UE may perform DL (downlink) synchronization and/or TA (timing advance) acquisition with one or more of the candidate target cells. This is before the UE receives the LTM cell switch command.

DL synchronization for candidate cell(s) before cell switch command may be based on, for example, at least SSB (synchronization signal block).

TA acquisition of candidate cell(s) before the cell switch command may be supported at least in part by PDCCH (physical downlink control channel) ordered RACH (random access channel), where the PDCCH order is only triggered by source cell.

The LTM execution phase will now be described.

As referenced 5, the UE performs L1 measurements on the one or more configured LTM candidate target cells, and transmits lower-layer measurement reports to the gNB.

The lower-layer measurement reports may be carried on L1 or on the L2 or MAC layer.

As referenced 6, the gNB decides to execute a LTM cell switch to a target cell, and transmits a MAC CE (control element) triggering LTM cell switch. This may include the candidate configuration index of the target cell.

The UE will detach from the source cell. The UE will apply the configurations for the LTM candidate target cell.

As referenced 7, the UE performs a random access procedure towards the target cell, if the TA is not available.

The LTM completion phase is now described.

As referenced 8, the UE indicates successful completion of the LTM cell switch towards target cell. An uplink signal or message may be sent to the gNB after the UE has switched to the target cell to indicate that the UE has switched to the target cell.

Some embodiments allow that the UE attempts to access LTM candidate target cells upon RLF (radio link failure) in the serving cell. The UE attempts to access LTM candidate target cells, before starting a fresh cell selection procedure;

The LTM candidate target cells may have been already prepared. The UE context may be available. This may be due to prior configurations inside the network. There may be a serving gNB and a target gNB. There may be a CU. The target cell gNB may serve further cells to which the UE has a connection.

A target cell may be prepared as discussed in the following examples. The CU may control the serving gNB-DU and the target gNB-DU. In some embodiments, the serving and target gNB-DU may communicate without the CU. The CU may establish a relation between the source and target DUs regarding the cells to be measured by the UE and regarding the candidate target cells for LTM. These candidate target cells may be configured at the UE before RLF via serving DU.

For LTM operation of the UE in the target cell, resources have been allocated, prepared, and configured in the target cell. This may be by the target DU, by the CU, or by both.

Based on measurement results advising which target cells may be candidates for LTM operation of the UE, the CU configures those candidates target cells at the UE. This may be via RRC signalling via the serving gNB-DU. The CU prepares/configures gNB-DUs supporting those target cells for LTM operation of the UE. For example the CU sends the UE context to target gNB-DU which includes information on the UE and its communication status to the network. This may trigger radio resource preparations in the target cell for LTM operation, and resource preparations for a user plane connection towards the CN via CU (user plane part). When UE attempts to access the target cell for LTM operation in the completion phase, target cell is enabled to proceed without further delay caused by preparing a connection for the UE.

It should be appreciated that in other embodiments, a target cell may be prepared in a different manner.

Some embodiments may introduce an error tolerance into the cell change procedures. The serving cell and the UE detect RLF, but expect the UE to “come back” in the serving cell or in any of the configured candidate target cells. Since one or more target cells for LTM have been configured, the UE attempts to access those target cells before the UE starts a normal cell search procedure. This normal cell search procedure may cause even longer delays to re-establish a connection to the network.

Some embodiments propose that the UE attempts to access LTM candidate target cells upon RLF in the serving cell. In some embodiments UE starts cell selection/RRC re-establishment procedure on the LTM candidate target cell(s)s.

LTM candidate target cells may have been already prepared i.e. the UE context is available, due to prior configurations inside the network (serving gNB-DU, target gNB-DU, CU). The gNB CU provides the configurations via the serving gNB-DU. The gNB provides configurations to the UE over RRC signalling. The target gNB-DU can then be the prepared entity and have the UE context available at the time of LTM trigger.

A target DU which receives the UE signals to operate in LTM, will inform the CU accordingly. This indicates to the CU that CU should not immediately release UE context and resources despite the notification from serving cell that RLF occurred, This would allow the target DU to continue with the LTM operation of the UE. Thus, the aim is that the target DU will change into serving cell and serving DU triggered by the CU.

LMT candidate target cells may be prepared and starting cell search/selection/RRC re-establishment procedure towards those candidate LTM target cells may be more successful than starting the cell search/selection procedure from scratch.

Embodiments may be applied where there is a RLF in the source cell before any mobility command has been received from the source cell to cause the UE to more to the target cell.

When an RLF occurs in the source cell, the UE needs to determine whether it is allowed to access a cell of the candidate target cells via LTM completion or a random access procedure. This may be based on an evaluation of the candidate target cell. For example a candidate cell with the highest signal power or quality may be selected. If that is not possible, the UE will start a cell search or selection process.

One or more network NW entities may allow completion of LTM for a UE. The network entity may be the target gNB-DU and/CU. This may be for a pre-determined period of time at CU, DUs, This completion may be allowed even though a RLF has been detected and reported by the source gNB-DU to CU.

The CU may delay the removal of already allocated resources related to ongoing procedures for a UE with RLF for a pre-determined period of time.

In some embodiments, the UE can attempt LTM completion after a RLF (radio link failure has occurred in the source cell (e.g., source SpCell/PCell/PSCell). “Special Cell” which is a common name used to call functions of PCell or PSCell in the MAC layer.

In some embodiments, a RLF occurs with the source cell before a path switch command is received. That is before the signalling referenced 6. If the RLF occurs with the source cell after the path switch command occurs, then the UE will switch to the target cell based on the switch command.

In some embodiments, a RLF on the source cell after the receipt of the LTM candidate cells in the signalling referenced 2 may result in the UE attempting LTM completion using the candidate cells. Embodiments may be used where the RLF would happen after, after the UE has received the candidate target cell(s) configuration and (optionally) confirmed this to NW.

In some embodiments, the UE attempts to complete LTM on the configured LTM candidate target cell(s) after RLF occurred.

In some embodiments, the UE attempts to complete LTM on the configured LTM candidate target cell(s) after RLF occurred. This may only be done if one or more LTM candidate target cell(s) fulfil at least one threshold and/or one or more condition. For example, the threshold may be a measurement power threshold and/or a quality threshold. For example, the condition may be that the measurement reporting event was fulfilled by the UE. The condition may be that the candidate target cell(s) are already reported. That is the UE has sent a measurement report to the gNB including the candidate target cell(s). This measurement report maybe based on a measurement event trigger. The measurement report may including information on the candidate cell. The information on the candidate cell may comprise one or more of cell id, signal quality, signal strength, which measurement reporting event triggered the report and/or the like.

In some embodiments, the at least one threshold comprises one or more of: (L1) RSRP (reference signal received power) threshold; a RSRQ (reference signal received quality) threshold; or a SINR (signal to interference noise ratio) threshold.

In some embodiments, the UE may attempt to complete a LTM after a RLF occurred on the configured LTM candidate target cell or set of cells for which UE has measured and/or reported highest (L1) RSRP to the NW. This may be reported to the CU via the source DU.

In some embodiments, the UE attempts to complete LTM after a RLF occurred on the candidate target cell(s) where the UE has: performed DL synchronization; performed TA acquisition; and/or where the UE has valid TA. This may be based on for example LTM configuration information).

In some embodiments, the UE attempts to complete LTM on the configured LTM candidate target cell(s) by performing random access procedure towards the target cell, if TA is not available.

In some embodiments, the UE attempts to complete LTM on the configured LTM candidate target cell(s) by indicating successful completion of the LTM cell switch towards target cell. The indication may be an uplink signal or message.

In some embodiments, the UE indicates in a RRC reconfiguration complete message that the LTM was performed due to failure in the source cell or without the LTM command by the NW (i.e. . . . , by the source cell).

The UE may indicate the source cell information in the RRC reconfiguration complete message. For example the PCI (physical layer cell identifier) may be used to identify the source cell. This may be so the NW may start, e.g., a path switch procedure and/or the like inside the NW. The UE may identifies itself in the message. For example, the UE may identify itself by a C-RNTI (cell radio network temporary identifier) MAC CE in the Msg3 of RA procedure in the target cell. This may be as done in for example, legacy HO.

In some embodiments, the UE initiates a new RRC procedure and/or transmits a new RRC message towards the network node when UE can select one of the at least one LTM candidate target cells in cell selection after RLF occurred. This is based on the fact that the target cell is prepared for the UE and has the UE configuration.

For example, such a RRC message (e.g., a RRC Request message) could comprise one or more of: a UE ID in the target cell as configured in the LTM configuration (e.g., C-RNTI cell radio network temporary identifier); information of the source cell (e.g. PCI); and/or security information. The security information may be, for example, shortMAC-I (message authentication code-integrity), generated based on the target cell configuration information so that the target cell can check the UE integrity without the information from the source cell). This RRC message may be transmitted over SRB0 (signalling radio bearer) or any other suitable SRB. The source cell information may be utilized to start path switch procedure inside the NW.

In one example, the NW configures the UE to attempt LTM after an RLF.

In some embodiments, the NW configures the UE to attempt LTM completion on one or more candidate target cells after RLF.

In some embodiments, the NW may configure the UE to attempt LTM completion on the candidate target cell(s) where the UE has performed DL synchronization and/or TA acquisition.

In some embodiments, if LTM completion is unsuccessful, then UE starts cell search/selection procedure/RRC Re-establishment procedure using the candidate cells, before starting the usual full cell search on all frequencies. This may be carried out after RLF has occurred in the source cell (e.g., source SpCell/PCell/PSCell).

In the full search procedure, a UE performs cell search to determine whether there is radio coverage at the location of the UE from at least one cell. Therefore, the UE scans the radio signals e.g., from lower to higher frequencies, and determines whether there is a radio signal of a cell. If there are more than one cell providing radio coverage, the UE selects one cell to start the communication with the cellular network. Usually, the UE selects a cell which provides the strongest signals and attempts to establish a RRC connection to the cellular network via this cell. In contrast, in embodiments, the UE may select one or more of the candidate cells rather than doing a full search.

During the RRC establishment procedure, the UE notifies the network nodes about the supported UE capabilities. When the RRC connection is interrupted, for example due to low radio coverage or low radio signals, and when radio coverage is obtained again, a RRC Re-establishment is executed with the new cell of the cellular network. The UE reuses parts of its previous RRC connection data during the RRC Re-establishment to notify the cell about previous connection for a faster synchronisation between UE and network. If the new cell does not identify the UE from an earlier connection, a full RRC establishment procedure is triggered which causes additional delay and signalling efforts. In some embodiments, the UE may attempt a RRC re-establishment procedure.

Thus, the UE may use the configured LTM candidate target cells in cell selection after RLF occurred.

The UE searches LTM candidate target cells first.

The UE may attempt to receive SSB and system information from LTM candidate target cells first.

In some embodiments, the UE prioritizes the configured LTM candidate target cells in cell selection (after RLF occurred) which fulfil at least one measurement quality threshold or a threshold configured for a measurement report event trigger.

In some embodiments, the UE will only attempt to access configured LTM candidate target cells in cell selection (after RLF occurred) which fulfil at least one measurement quality threshold or a threshold configured for a measurement report event trigger.

In one option, the at least one measurement quality threshold or a threshold configured for a measurement report event trigger consists of a RSRP threshold or a RSRQ threshold or a SINR threshold.

In some embodiments, the UE prioritizes the configured LTM candidate target cell(s) or a set of cell(s) in cell selection (after RLF occurred) for which the UE has measured and/or reported highest (L1) RSRP or RSRQ or SINR to the NW.

In some embodiments, the UE uses configured LTM candidate target cells in RRC Re-establishment after RLF occurred i.e., the UE attempts RRC Re-establishment on the LTM candidate target cells first.

In some embodiments, the UE may attempt cell selection and/or radio resource control re-establishment.

Cell selection may be part of the RRC re-establishment procedure.

In one some embodiments, the UE prioritizes configured LTM candidate target cells/frequencies after RLF occurred.

In some embodiments, the UE attempts cell selection/re-establishment on the candidate target cell(s) where the UE has performed DL synchronization and/or TA acquisition and/or where the UE has valid TA (e.g., based on LTM configuration information).

In some embodiments, the UE initiates RRC Re-establishment procedure in case LTM completion after RLF fails.

In some embodiments, a UE in RRC_CONNECTED state or other connected may initiate a RRC re-establishment procedure or other re-establishment procedure to continue the RRC or other connection when a failure condition occurs. The failure condition may be a radio link failure, a reconfiguration failure, an integrity check failure, or other failure condition.

In some embodiments, the network (e.g. target gNB-DU, CU) allows completion of LTM for UE (for a pre-determined period of time at CU, DUs), even though RLF has been detected and reported by source gNB-DU to CU. In some embodiments, the network may set a timer.

The CU may delay the removal of already allocated resources related to ongoing procedures for a UE with RLF for a pre-determined period of time. This time may be controlled by the timer.

In some embodiments, the UE may send one or more capability indicators to the network.

A first indicator may notify the network that the UE is capable of attempting to complete the mobility procedure in the event of an RLF.

A second indicator may notify the network that the UE will attempt cell search/selection initially using the candidate cells as a starting point.

In some embodiments, a single indicator or combined indicator may be used instead of the first and second indicators.

In some embodiments, only one of the first and second indicators may be supported. In some embodiments, the UE will indicate to the gNB that it is capable of supporting LTM completion in the event of a RLF failure. This may be provided by a capability indication.

The gNB may use this information such that when there is an RLF, the resources associated candidate cells are not immediately removed.

In some embodiments, the gNB will indicate to the UE, that the UE should attempt LTM completion in the event of a RLF failure. This may be provided by an indicator. This may be provided during the set-up of the connection. The UE may use this information to attempt LTM completion in the event of a RLF failure.

In some embodiments, there may be a message exchange between the UE and gNB so that both the UE and the gNB know that the LTM completion in the event of a RLF failure behaviour is not only supported but is implemented.

In some embodiments, a RLF is declared by the UE when one or more of the following criteria is met:

Expiry of a radio problem timer started after indication of radio problems from the physical layer (if radio problems are recovered before the timer has expired, the UE stops the timer); or

Expiry of a timer started upon triggering a measurement report for a measurement identity for which the timer has been configured while another radio problem timer is running; or

Random access procedure failure (e.g., number of preamble transmissions reaches a configured threshold); or

RLC (radio link control) failure (e.g., number of RLC re-transmissions reaches a configured threshold); or Detection of consistent uplink LBT (listen before talk) failures for operation with shared spectrum channel access; or

For IAB-MT (integrated access and backhaul mobile termination), the reception of a BH (backhaul) RLF indication received from its parent node. Backhaul is the connection between two cells.

In some embodiments, the UE is allowed to attempt LTM completion on candidate target cells after a RLF. This may minimize the delay in completing a successful completion LTM cell switch.

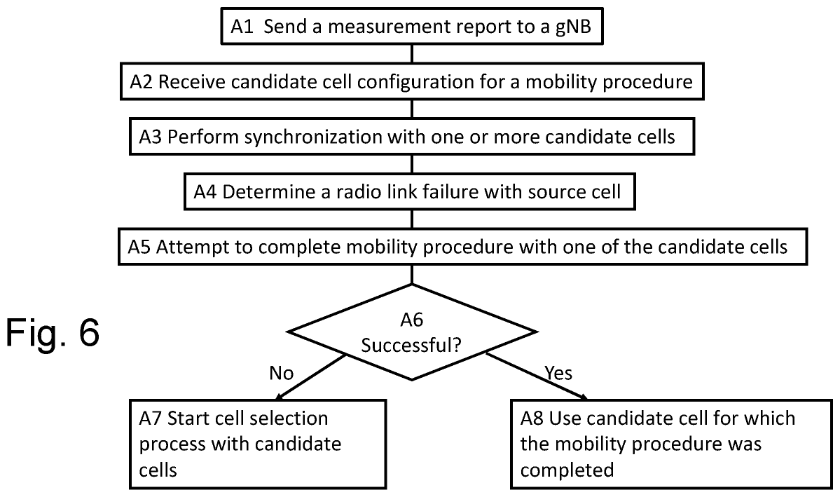

Reference is made to FIG. 6 which shows a method of some embodiments. The method may be performed by an apparatus. The apparatus may be a UE or provided in a UE.
As referenced A1, the apparatus is configured to cause a measurement report to be sent to the gNB. This may be sent to the CU via the source DU.
As referenced A2, the apparatus receives candidate cell configuration for a mobility procedure. This candidate cell configuration may be received from the gNB. In particular, the candidate cell configuration may be received from the CU via the source DU.
As referenced A3, the apparatus is configured to cause a synchronisation to be performed with respect to one or more of the candidate cells.
As referenced A4, the apparatus is configured to determine that there has been a radio link failure with respect to the connection with the source cell.
As referenced A5, the apparatus is configured to attempt to complete the mobility procedure with one or more of the candidate cells. The apparatus may be configured to attempt to complete the mobility procedure with respect to a candidate cell for which these synchronisation has been performed
As referenced A6, a determination is made as to whether or not the mobility procedure has been successfully completed with one of the candidate cells.
As referenced A7, if the procedure has not been successful, then the apparatus is configured to start a cell selection process starting with the candidate cells. In other words, the apparatus is configured to start a cell reselection process and uses the candidate cells as a starting point.
As referenced A8, if the procedure has been successfully completed with one of the candidate cells, then the candidate cell becomes the new source cell for the apparatus.

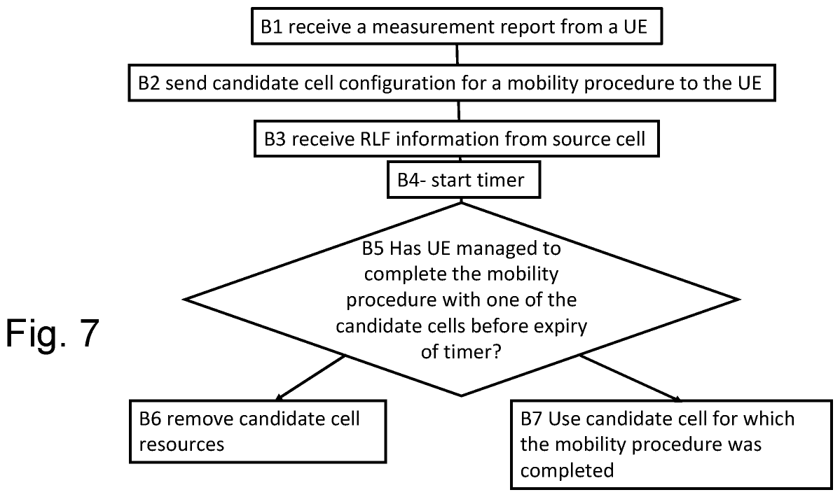

Reference is made to FIG. 7 which shows another method of some embodiments. The method may be performed by an apparatus.

The apparatus may be in or be a gNB. In some embodiments, the apparatus may be or be in a CU.
As referenced B1, the apparatus may receive a measurement report from a UE.
As referenced B2, the apparatus is configured to determine a candidate cell configuration for a mobility procedure. This is based on the measurement report received from the UE. The apparatus is configured to cause the candidate cell configuration for the mobility procedure to be sent to the UE.
As referenced B3, the apparatus is configured to receive radio link failure information from the source cell. This indicates that there has been a radio link failure between the source cell and the UE.
As referenced B4, the apparatus is configured to start a timer.
As referenced B5, the apparatus is configured to determine if the UE has managed to complete the mobility procedure with one or more of the candidate cells before the expiry of the timer. It should be appreciated that in some embodiments, the apparatus will determine that the UE has managed to complete the mobility procedure with one of the candidate cells in response to receiving a message from the UE before the timer has expired.
As referenced B6, if the UE has not managed to complete the mobility procedure before the expiry of the timer, then the resource is associated with one or more of the candidate cells is removed. In other words, the UE context which was set up with respect to the candidate cells is removed.
As referenced B7, if the UE has managed to complete the mobility procedure before the expiry of the timer, then the UE will use the candidate cell for which the mobility procedure was completed.

In some embodiments, the using of candidate cells as a starting point for a cell search/selection process may be done as soon as there is a RLF. In other words, the UE will not attempt to complete the LTM mobility process and start the cell section process using the candidate cells.

In the embodiments, where the UE will not attempt to complete the LTM mobility process and start the cell section process using the candidate cells, the RLF may occur at any time between the receipt of the LTM candidate cell configuration from the gNB and the receipt of the cell switch command.

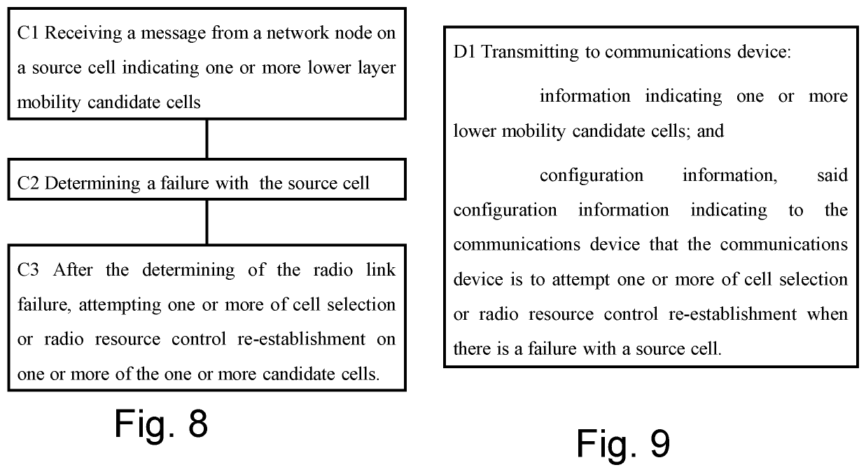

Reference is made to FIG. 8 which shows a method of some embodiments.

This method may be performed by an apparatus. The apparatus may be in or be an communications device.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 3 or 4.

The method may be provided by computer program code or computer executable instructions.
The method may comprise as referenced C1, receiving a message from a network node on a source cell indicating one or more lower layer mobility candidate cells.
The method may comprise as referenced C2, determining a failure with the source cell.
The method may comprise as referenced C3, after the determining of the radio link failure, attempting cell selection and/or radio resource control re-establishment on one or more of the one or more candidate cells.

It should be appreciated that the method outlined in FIG. 8 may be modified to include any of the previously described features.

Reference is made to FIG. 9 which shows a method of some embodiments.

This method may be performed by an apparatus. The apparatus may be in or be an access node.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 3.

The method may be provided by computer program code or computer executable instructions.

The method may comprise as referenced D1, transmitting to communications device: information indicating one or more lower mobility candidate cells; and configuration information, said configuration information indicating to the communications device that the communications device is to attempt at least one of cell selection or radio resource control re-establishment when there is a failure with a source cell.

The information indicating one or more lower mobility candidate cells and the configuration information can be sent in a same message or in different messages.

It should be appreciated that the method outlined in FIG. 9 may be modified to include any of the previously described features.

Computer program code may be downloaded and stored in one or more memories of the relevant apparatus or device.

Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, an integrated circuit such as a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiments of this disclosure. However, various modifications and adaptations may become apparent to those skilled in the relevant arts in view of the foregoing description, when read in conjunction with the accompanying drawings and the appended claims. Indeed, there are further embodiments comprising a combination of one or more embodiments with any of the other embodiments previously discussed. The scope of protection sought for some embodiments of the disclosure is set out by the claims. The embodiments and features, if any, described in this specification that do not fall under the scope of the claims are to be interpreted as examples useful for understanding various embodiments of the disclosure. It should be noted that different claims with differing claim scope may be pursued in related applications such as divisional or continuation applications.

1. An apparatus comprising at least one processor and at least one memory including computer code for one or more programs, the at least one memory and the computer code being configured, with the at least one processor, to cause the apparatus at least to:
receive a message from a network node on a source cell indicating one or more lower layer mobility candidate cells;
determine a failure with the source cell; and
after determining the failure, attempt at least one of cell selection or radio resource control re-establishment on one or more of the one or more candidate cells.

2. The apparatus as claimed in claim 1, wherein the failure comprises a radio link failure.

3. The apparatus as claimed in claim 1, wherein the attempting at least one of cell selection or radio resource control re-establishment on one or more of the one or more candidate cells is performed in the absence of a path switch command from the network.

4. The apparatus as claimed in claim 1, wherein attempting at least one of cell selection or radio resource control re-establishment is for attempting to receive system information from one or more or the one or more candidate cells.

5. The apparatus as claimed in claim 1, wherein attempting at least one of cell selection or radio resource control re-establishment prioritizes one or more of the one or more candidate cells satisfying one or more thresholds or at least one condition.

6. The apparatus as claimed in claim 5, wherein the at least one threshold comprises a measurement power threshold or a quality threshold.

7. The apparatus as claimed in claim 5, wherein the at least one condition comprises that one or more of the one or more candidate cells has been reported in a measurement report to the network node.

8. The apparatus as claimed in claim 1, wherein the message comprises configuration information for one or more of the one or more candidate cells.

9. The apparatus as claimed in claim 1, being further configured to cause a measurement report to be transmitted to the network node said message being received in response to said measurement report.

10. The apparatus as claimed in claim 1, wherein the lower layer mobility comprises a L1/L2 triggered mobility.

11. The apparatus as claimed in claim 1, being further configured to attempt completion of lower layer mobility to a target cell selected from one of said one or more candidate cells, in response to the determining of the failure, and when said attempt to complete the lower layer mobility to said target cell is unsuccessful, to attempt at least one of cell selection or radio resource control re-establishment on one or more of the one or more candidate cells.

12. The apparatus as claimed in claim 1, being further configured to synchronise with one or more of the one or more candidate cells.

13. The apparatus as claimed in claim 1, being further configured to acquire timing advance information for one or more of the one or more candidate cells.

14. The apparatus as claimed in claim 1, being further configured to send information to the network node, said information indicating that the apparatus supports at least one of:
completion of lower layer mobility to a target cell selected from the one or more candidate cells after a failure; or
after a failure, attempting at least one of cell selection or radio resource control re-establishment on one or more of the one or more candidate cells.

15. An apparatus comprising at least one processor and at least one memory including computer code for one or more programs, the at least one memory and the computer code being configured, with the at least one processor, to cause the apparatus at least to:
transmit to a communications device:
information indicating one or more lower mobility candidate cells; and
configuration information, said configuration information indicating to the communications device that the communications device is to attempt at least one of cell selection or radio resource control re-establishment when there is a failure with a source cell.

16. The apparatus as claimed in claim 15, wherein the failure comprises a radio link failure.

17. The apparatus as claimed in claim 15, wherein the information indicating one or more lower mobility candidate cells comprises configuration information for one or more of the one or more candidate cells.

18. The apparatus as claimed in claim 15, being further configured to receive a measurement report from the communications device.

19. The apparatus as claimed in claim 15, wherein the lower layer mobility comprises a L1/L2 triggered mobility.

20. The apparatus as claimed in claim 15, being further configured to receive from the communications device information that the communications device supports at least one of:
completion of lower layer mobility to a target cell selected from the one or more candidate cells after a failure; or
after a failure, attempting at least one of cell selection or radio resource control re-establishment on one or more of the one or more candidate cells.

21. The apparatus as claimed in claim 15, being further configured to determine a failure with the source cell and in response to start a timer to delay removal of resources associated with the one or more candidate cells.

22. The apparatus as claimed in claim 21, wherein said timer is started in the absence of a path switch command being caused to be transmitted to the communications device.

23. A method comprising:
receiving a message from a network node on a source cell indicating one or more lower layer mobility candidate cells;
determining a failure with the source cell; and
after the determining of the failure, attempting at least one of cell selection or radio resource control re-establishment on one or more of the one or more candidate cells.

24. A computer program comprising computer executable instructions which when run cause the method of claim 23 to be performed.
